(19) United States
(12) Patent Application Publication
(10) Pub. No.: US 2004/0015540 A1
(43) Pub. Date: Jan. 22, 2004

(54) Modular, extendible application server that is distributed across an electronic data network and method of making same

(76) Inventors: Daniel Solano, Austin, TX (US); Damon Williams, Austin, TX (US); Dan Bereczki, Austin, TX (US); John Alirez, Austin, TX (US); Kevin Graham, Austin, TX (US)

Correspondence Address: Erik B. Cherdak & Associates, LLC, Suite 906, 11300 Rockville Pike, Rockville, MD, 20852, US

(21) Appl. No.: 10/200,064

(22) Filed: Jul. 22, 2002

(51) Int. Cl. G06F 15/16

(52) U.S. Cl. 709/203

(57) ABSTRACT

An extendible, modular application server distributed via an electronic data network (e.g., the Internet and World Wide Web, a local area network, etc.) that includes a remote client facility, at least one business function facility, at least one remote network facility, and at least one facility manager. The remote client facility is configured to receive a request via the electronic data network from a network client, to register the network client, to locate a first network facility residing on the electronic data network based on the request and reference the client to the first network facility in order to initiate a distributed application. Said at least one business function facility resides on the electronic data network and is configured to access and control a second network facility corresponding to the first network facility in order to perform a business function. Said at least one remote network facility resides on the electronic data network and is configured to be accessed and controlled by at least one business function facility in order to facilitate the aforementioned business function. Said at least one remote network facility includes the second network facility corresponding to the first network facility. The facility manager is configured to track, manage and maintain the remote client facility, said at least one business function facility and at least one remote network facility, to locate, load and execute in memory the first network facility and the second network facility to complete delivery of the application to the network client via the electronic data network.

### BACKGROUND OF THE INVENTION

1. Field of the Invention

The present invention relates to systems and methods for serving computer software applications. More particularly, the present invention relates to middle-tier application servers that are extendible and modular, and those which are designed to serve and implement distributed applications, especially enhanced web applications.

2. Description of the Related Art

Commercial use of the Internet has increased both in kind and magnitude. The popularity of the Internet and World Wide Web (WWW) in commerce has made network computing increasingly more important in today's environment. Many companies are making information available to the public over the Internet that has been previously unavailable. More and more companies are tying their core business systems to the Internet. And, whole industries have sprung up to support Internet commerce.

Delivering rich content to customers is of utmost importance in such a competitive market. As companies rely more and more on the Internet to perform core business functions, content providers on the Internet must find new ways to deliver customized interfaces and web sites (e.g., customized “look and feel,” functionality, etc.) in order to properly support the changing requirements of their customers. Additionally, content providers may be required to maintain and provide the same or similar data to multiple customers in multiple interfaces based on such requirements.

Another important function that may be required in today's business environment is localization, or internationalization. The Internet by its nature provides companies that otherwise would be unable to compete internationally, an easy way to access international markets and offer their services. Accordingly, Internet content providers may serve international customers that require that their content be provided in specific formats or languages depending on their locale (e.g., in Spanish, etc.). Thus, in order to be competitive internationally, content must also be localized for customers.

Furthermore, Internet commerce moves at a rate that is substantially faster than the “old economy.” Accordingly, web sites are deployed at an incredible rate, and customers expect web designers to provide reliable integrated web applications quickly and inexpensively. Content and application providers on the Internet are developing and hosting enhanced web applications to fulfill their customers various needs. However, hosting such applications has become more difficult because of the aforementioned issues and developments. For example, customers may require constant modification to their applications, such as adding new functions or modifying current ones, to keep up with competitors or to fulfill their customers need, etc. Rapid development of enhanced web applications and modifications thereto cause many problems maintaining and serving such applications.

One problem that content and application providers encounter is maintaining a high level of availability (i.e., a low amount of downtime). As modifications are made to applications, such as modules being added and modified, often an application must be entirely shut down so that the new version of the application may be loaded, or alternatively, portions of an application might necessarily be shut down until the new portion is loaded. However, many customers require “24 by 7” coverage, and the constant shutdowns, no matter how brief, can significantly hinder a customer's business.

Another problem application and content providers encounter relates to maintaining such web applications. As modules are added to applications and modified, versions tend to get out of sync with one another, and often errors occur in an application because a shared module has been updated without updating other related dependent modules. Alternatively, duplicative modules are often updated piecemeal, so that modules that perform the same or similar functions become out of sync and begin to perform inconsistently with one another because of bad version control. Furthermore, business to business solutions (B2B) often require sharing or linking data, modules, web sites, etc. between distinct business entities, which exacerbates compatibility and maintenance issues because, software modules may be distributed across a number of separate network devices owned and maintained by separate business entities.

Another problem content and application providers find relates to rapid development. Often, in the current business environment, a company's success depends in a large part on its ability to be first to the market with a product, innovation, etc. Therefore, rapid development and modification of enhanced web applications is extremely important to many such companies. However, large and complex programs are often difficult to develop quickly without significantly reducing the quality of such programs. And, such applications often require many of the same standard functions, such as credit card validation, data entry, security, etc. Therefore, in order to rapidly develop and modify enhanced web applications, developers wish to take advantage of common functions by sharing them between applications.

Thus, there exists a need to provide new and improved systems and methods of service enhanced web applications to solve the aforementioned problems. Such systems and methods should utilized extendible application servers that support modular application design, localization, that may be distributed across an electronic data network, and that are dynamically updateable.

The present invention squarely addresses the aforementioned problems and delivers such new and improved systems and methods which are described in detail below.

### SUMMARY OF THE INVENTION

The present invention solves the aforementioned problems and provides new and improved systems and methods delivering distributed appellations via an electronic data network, such as the Internet and World Wide Web. Furthermore, the present invention provides for an application server system that is extendible and distributable. The present invention provides for modular design and novel ways of managing and sharing modules (i.e., system components, services, servants, daemons, facilities, etc.).

Many benefits will be appreciated from the present invention. For example, modular designs allow many applications distributed across a network or networks (the Internet and WWW), to share modules of code and facilities, thus improving maintainability, extendibility, efficiencies of scale, etc. Furthermore, the present invention provides version control and system component management that improves availability and allows for easy updating of code without shutting down corresponding modules in use, for example.

The present invention solves the aforementioned problems and provides the above-stated benefits by providing new and improved systems and methods for serving distributed applications via an electronic data network. According to a preferred embodiment of the present invention, provided is an extendible, modular application server system distributed via an electronic data network (e.g., the Internet and World Wide Web, a local area network, etc.) that includes a remote client facility, at least one business function facility, at least one remote network facility, and at least one facility manager. The remote client facility is configured to receive a request via the electronic data network from a network client, to register the network client, to locate a first network facility residing on said electronic data network based on the request and reference the client to the first network facility in order to initiate a distributed application. Said at least one business function facility resides on the electronic data network and is configured to access and control a second network facility corresponding to the first network facility in order to perform a business function. Said at least one remote network facility resides on the electronic data network and is configured to be accessed and controlled by at least one business function facility in order to facilitate the aforementioned business function. Said at least one remote network facility includes the second network facility corresponding to the first network facility. The facility manager is configured to track, manage and maintain the remote client facility, said at least one business function facility and at least one remote network facility, to locate, load and execute in memory the first network facility and the second network facility to complete delivery of the application to the network client via the electronic data network.

According to another embodiment of the present invention, provided is an extendible, modular application server system distributed via an electronic data network, including a network client, a web server facility, a remote client facility, at least one business function facility, at least one remote network facility, and a facility manager. The network client is configured to access a web server facility via the electronic data network to receive and execute at least one web interface. The web server facility is coupled to the electronic data network and configured to store and to serve said at least one web interface, said at lest one web interface being configured to initiate an application by making a request via the electronic data network. The remote client facility is configured to receive a request via the electronic data network from said at least one web interface executing on the network client, to register the network client, to locate a first network facility residing on the electronic data network based on the request and to reference the network client to the first network facility in order to initiate a distributed application. Said at least one business function facility resides on the electronic data network and is configured to access and control a second network facility in order to perform a business function, said at least one business function facility including said first network facility. Said at least one remote network facility resides on the electronic data network and is configured to be accessed and controlled by said at least one business function facility in order to facilitate the business function; said at least one remote network facility includes the second network facility which corresponds to the first network facility. The facility manager is configured to track, manage and maintain the remote client facility, said at least one business function facility and said at least one remote network facility, to locate, load and execute in memory network facilities residing on the electronic data network, to partially load the first network facility into memory to locate and load the second network facility which corresponds to the first network facility and to complete loading the first network facility to complete delivery of the application to the network client via the electronic data network.

And, according to another preferred embodiment of the present invention, provided is a method for serving modular, distributed applications comprising the steps of: at a network client, accessing a remote client facility via an electronic data network and passing a service request to the remote client daemon; next, at the remote client daemon, locating a first network facility based on the request, registering the network client, and referring the first network facility to the network client; next, at a servant managing facility, partially loading the first network facility; at the servant managing facility, determining at least one second network facility necessary to execute the first network facility; next, at the servant managing facility, locating and loading the second network facility; and, at the servant managing facility, completing loading the first network facility to fulfill the service request to the network client.

### BRIEF DESCRIPTION OF THE DRAWING FIGURES

The present invention is described in detail below with reference to the attached drawing figures, of which:

FIG. 1 is a block diagram of an extendible, modular application server system that is distributed across an electronic data network in accordance with a preferred embodiment of the present invention;

FIG. 2 is a logical diagram of an extendible, modular application server system in accordance with a preferred embodiment of the present invention;

FIG. 3 is a block diagram of a data processing system that may be used to implement a system for generating a customized web interface via an electronic data network in accordance with a preferred embodiment of the present invention;

FIG. 4 is flow chart of a method distributing and serving enhanced web applications via an electronic data network in accordance with a preferred embodiment of the present invention;

FIG. 5A is a flow chart of a method for managing JAVA servants in accordance with a preferred embodiment of the present invention;

FIGS. 5B-5H depict the servants and their states and relationships during the steps of the method of FIG. 5A according to a preferred embodiment of the present invention; and

FIG. 6 is a flow chart of a method for upgrading a system component without making the system component unavailable in accordance with a preferred embodiment of the present invention.

### DETAILED DESCRIPTION OF THE PREFERRED EMBODIMENTS

Now, salient features of the present invention are discussed in detail with regard to the attached drawing figures which were briefly described above. Unless otherwise indicated, like parts and processes are referred to with like reference numerals.

For the purposes of the following discussions, the following terms are intended to have the following means:

A service is any computer program, module or the like, that communicates with a network client outside an application server system and provides a valuable business function.

A daemon is an internal computer program, module or the like, that performs a basic or common function and does not communicate directly with a network client. Daemons are typically called by services or other daemons.

A facility is a system component (e.g., program, server system, service, daemon, etc.) that may be hardware, software or a combination thereof.

A servant is a modular piece of code which runs within the application server system framework. For example, a servant may be an object in an object oriented framework, a JAVA servant, servlet, program, etc.

### Application Server Framework

This patent application is based in part on technologies and methodologies described in co-owned, co-pending U.S. patent application Ser. No. ______, entitled “SYSTEM AND METHOD FOR GENERATING DYNAMIC WEB INTERFACES THAT ARE CUSTOMIZED AND LOCALIZED,” filed on ______, 2000, and is hereby incorporated by reference. That patent application describes an extendible, distributable application framework for providing custom web interfaces and enhanced web applications that are dynamically generated and may be served and implemented by the present invention in accordance with a preferred embodiment thereof. And, that patent document should be referred to for the purpose of disclosing technologies (i.e., programs, facilities, interfaces, frameworks, etc.), methodologies related to that framework and system and methods generating of dynamic web interfaces and enhanced web applications that are customized and localized.

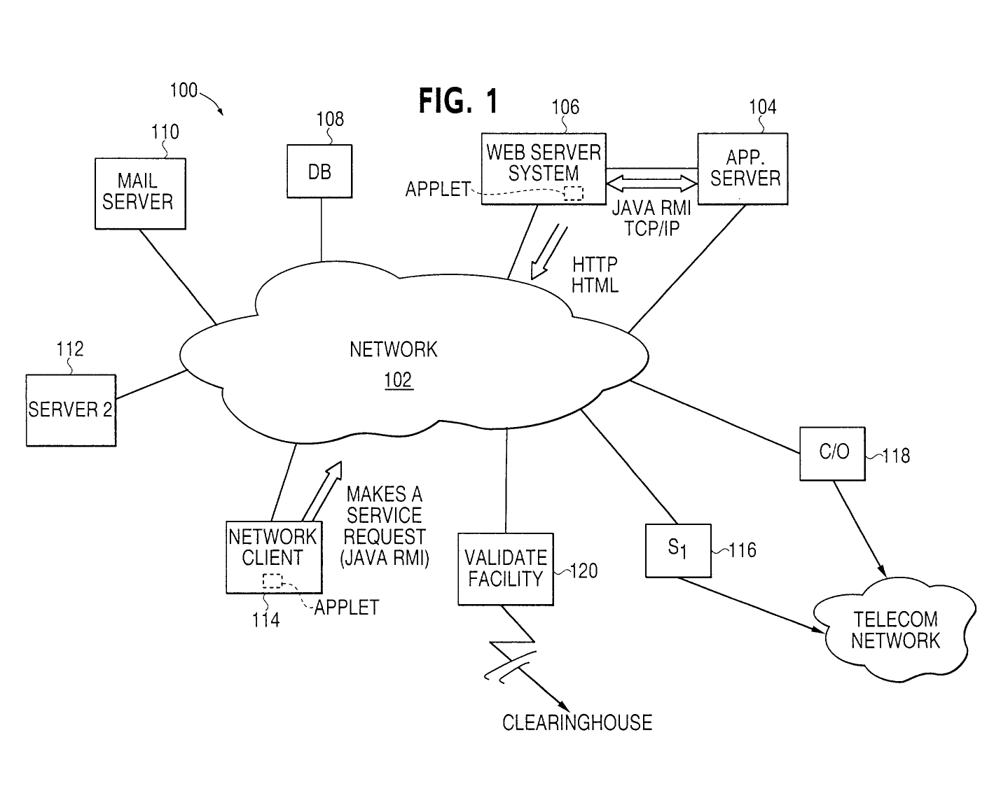

Referring now to FIG. 1, depicted therein is a block diagram of an extendible, modular application server system that is distributed across an electronic data network in accordance with a preferred embodiment of the present invention. In particular, system 100 includes an electronic data network 102, which may include the Internet and World Wide Web (WWW), an application server facility 104, a web server facility 106, and a network client 114. In a typical arrangement, application server facility 104, web server facility 106 and network client 114 are connected to the network (Internet and WWW) 102 in conventional fashion (e.g., modem, ISP, ISDN, etc.).

Application server facility 104, web server facility 106, and network client 114 work together to facilitate the delivery of applications, such as enhanced web applications, to network client 114. Applications may be distributed across and utilize many network resources such as application server facility 104, web server facility 106, and network client 114, as well as a database 108, a mail server 110, another server facility 112, and telecommunications devices switch 116 and central office 118, and validation facility 120. It will be readily understood by one having ordinary skill in the art that various types of modular applications may be distributed across and utilize many other network resources after reviewing this patent document and all its attachments.

Application server facility 104 may be any robust application server that serves as the central processing unit of the present invention in accordance with a preferred embodiment. Preferably, application server facility 104 is a server system, such as a Hewlett Packard L Class Server running an HP-UX operating system configured to run a JAVA based server system, to store and to serve files via network 102, and to communicate with other network facilities (e.g., via HTTP, TCP/IP, JAVA RMI, etc.). Accordingly, such a server system may be outfitted appropriately with runtime engines, compilers, etc., in order to facilitate system 100 in accordance with a preferred embodiment of the present invention.

Web server facility 106 may be any conventional web server coupled to the network (Internet and WWW) 102, connected to database facility 106 and configured to store and to serve files (HTML, XML, CSS, and XLS files, java applets, servlets and programs, etc.), to communicate with other network facilities (e.g., via HTTP, TCP/IP, JAVA RMI, etc.), and to execute programs and interfaces that facilitate the present invention. Accordingly, web server facility 106 can be any server system with a commercially available web server system installed, such as APACHE or IPLANET WEB SERVER, and may be appropriately outfitted to execute programs written and designed in commonly used languages such as JAVA, C++, etc., and therefore, may be outfitted with runtime engines and compilers to execute JAVA programs, applets, servlets, C++ programs, etc.

Database facility 108 may be a separate database server or, alternatively, may be a database engine running on application server facility 104, web server facility 106, or any other hardware device coupled to network 102 and configured to execute a database engine. Database facility 108 may also include any utilities, compilers, runtime engines, programs, etc. to facilitate the present invention in accordance with a preferred embodiment. Database server 108 may utilize any well known database engine, such as ORACLE 8I manufactured and marketed by ORACLE CORP., along with appropriate utilities, API's, etc. necessary to facilitate the present invention.

Network client 114 may be a web client coupled to the network (Internet and WWW) 102 (e.g., via ISDN, wireless modem, modem, DSL, etc.) and configured to run a web browser capable of accessing a URL to download and manifest a web page or interface, JAVA program or applet, or other computer programs according to a preferred embodiment of the present invention. For example, network client 114 may be a properly outfitted commercially available personal computer (PC) running a standard windows based operating system, such as WINDOWS 2000 manufactured and marketed by MICROSOFT CORP., and a web browser, such as NETSCAPE NAVIGATOR manufactured and marketed by NESCAPE COMMUNICATIONS CORP. Additional utilities, API's, plug-ins, etc. also may be installed on network client 114 in order to facilitate the present invention in accordance with a preferred embodiment. Additionally, network client 114 could be any network facility couple to network 102 and configured to interface with other network facilities within system 100, and in particular, a remote client facility (described later in this patent document) to make a service request. For example, an external application module executing on a remote computer processor may communicate (e.g., make a call via JAVA RMI, etc.) with application server facility 104 to request some sort of service (e.g., a JAVA servant, etc.).

Switch 116 and central office 118 are well known components of a telecommunication network and may be incorporated into system 100 to implement distributed applications related to providing telecommunications services.

The operations of an interface facility (not shown) that may be used to communicate with and control Switch 116, central office 118, and other disparate telecommunications devices are illustrated and described in detail in co-owned, co-pending U.S. patent application Ser. No. 09/414,668 entitled “SYSTEM AND METHOD FOR COMMUNICATING WITH AND CONTROLLING DISPARATE TELECOMMUNICATIONS DEVICES IN A TELECOMMUNICATIONS NETWORK,” filed on Oct. 7, 1999, which is incorporated herein by reference. Accordingly, the reader of this patent document should refer to the aforementioned co-owned, co-pending U.S. patent application for complete disclosure details related to the operations of an interfacing facility in the context of serving and implementing an enhanced web application that provides telecommunications services utilizing disparate telecommunications devices in accordance with the present invention.

Validation facility 120 may be incorporated into system 100 to implement distributed applications that require e-commerce capabilities and to validate credit card transactions, such as by connecting to a clearing authority and the like, or in the case of a telecommunications application, to validate a call (i.e., calling card call, credit card calls, etc.). An example of such a validation facility is disclosed and described in co-owned and co-pending U.S. patent application Ser. No. ______, entitled “SYSTEM AND METHOD FOR VALIDATING CALLS WITHIN A TELECOMMUNICATIONS NETWORK” filed on May 31, 2000, and is hereby incorporated by reference. Accordingly, the reader of this patent document should refer to the aforementioned co-owned, co-pending U.S. patent application for complete disclosure details related to the operations of a validation facility in the context of serving and implementing an enhanced web application that provides e-commerce capabilities related to telecommunications services in accordance with the present invention.

It will be appreciated by one having ordinary skill in the art that system components, modules, programs, etc. within system 100 may be distributed across and utilized the various network facilities within system 100. For example, system components may reside on application server facility 104, web server facility 106, and network client 114, as well as a database facility 108, a mail server 110, additional server facility 112, and telecommunications devices switch 116 and central office 118, and validation facility 120.

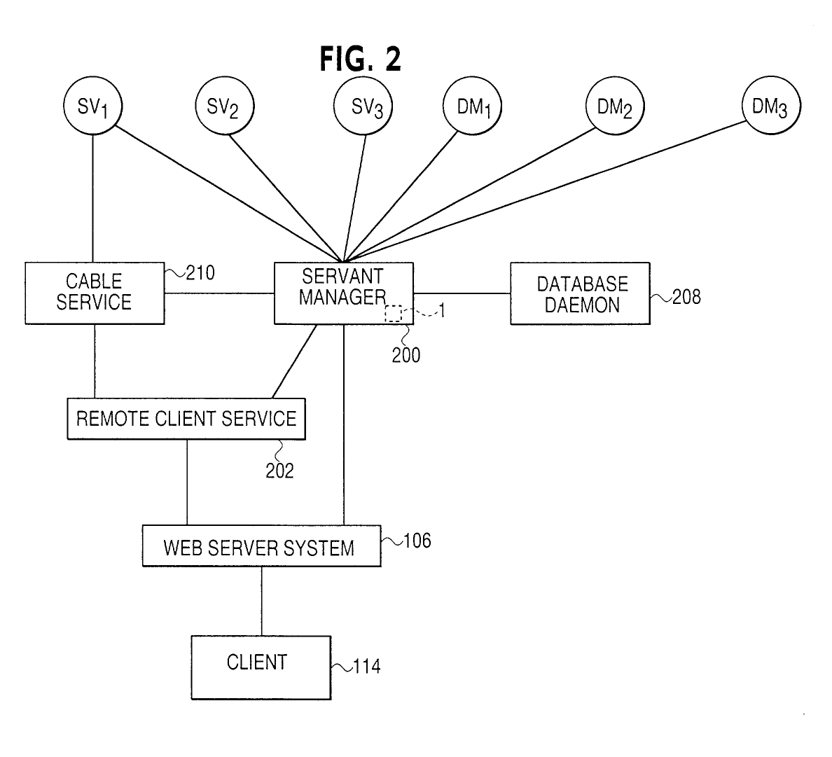

Referring now to FIG. 2, depicted therein is a logic diagram of an exemplary application server system that is extendible and modular, and is distributed across an electronic data network in accordance with a preferred embodiment of the present invention.

System 100 includes a servant manager 200, a web server facility 106, network client 114, remote client service 202 and a cable service 206, database daemon 208, and several servants and daemons, SV1-SV3 and DM1-DM3. The center, or “brain,” of system 100 and its framework is the servant manager 200. Servant manager 200 manages the various components of system 100, such as web server system 106, a client 114, remote client service 202 and a cable service 206, database daemon 208, and several servants and daemons, SV1-SV3 and DM1-DM3, and other servants, daemons, services, modules and facilities that make up system 100 or applications to be served therefrom. Servant manager 200 does this by maintaining data related to all system components and network facilities and through a system of rules. Data may be maintained by objects in memory, in database objects in database facility 108, or in external files (not shown).

System components are identified by the following:

1. Component ID: Used to identify the function of the servant (system component, sub-program, program, module, applet, class, subclass, etc.). This is determined at compile-time. For example, “dbdmn” is the component ID for the “Database Daemon”.

2. Version Number: A number in four parts with the format “a.b.c.d” where “a” is the version number, “b” is the major revision number, “c” is the minor revision number, and “d” is the build number. An example version number is “2.3.4.12”. Any two servants which share the same component ID, version number, and major revision number are said to be “compatible”. “Compatible” means that they share the same interface. “dbdmn 1.3.5.2” is compatible with “dbdmn 1.3.23.0”.

3. Servant ID: Used to identify an instance of a module loaded into application server system memory. This number is generated dynamically during runtime.

System components have six functions which are used by the servant manager 200:

1. <init>: The constructor, used to instantiate a new instance of a servant.

2. init( ): An initialization method, used to allow a system component to initialize itself. Implementation of this method is optional.

3. start( ): Notifies a system component that it should acquire resources and start running.

4. attenuate( ): Notifies a system component that it should stop accepting new actions and should begin releasing resources.

5. kill( ): Notifies a system component that it must release all resources immediately.

6. destruct( ): Allows a system component to clean itself up before being unloaded. Antithesis of init( ). Implementation is also optional.

System components may be dependent upon one or more other system components for operation. Take servant SV1. Servants SV2 and SV3 may be dependent upon servant SV1. Servant SV1 may depend on daemons DM1 and DM2. Servants SV2 and SV3 are known as servant SV1's “dependants” and daemons DM1 and DM2 are known as servant SV1's “dependencies”. A system component's dependencies are determined at compile-time. System component dependencies are defined using the dependency's component ID, version number, and major revision number.

System components can be in a number of states, including:

1. Unloaded->2 (System components not loaded, used as a placeholder)

2. Loading->3 (System components currently loaded)

3. Loaded->4 (System components loaded, but not initialized)

4. Initializing->5 (System components initializing)

5. Stopped*->6,11 (System components loaded and ready, but inactive)

6. Starting->7 (System components starting)

7. Started*->8,10 (System components fully active)

8. Attenuating->9 (System components becoming transient)

9. Transient*->10 (System components not accepting new activity)

10. Dying->5 (System components releasing all resources)

11. Destructing->12 (System components being taken out of service permanently)

12. Destructed->13 (System components ready for removal from memory)

13. Unloading->1 (System components being removed from memory)

The states marked with asterisks (*) are stable states. System components may remain in these for extended periods of time. All other states are intermediary states which are used only internally by the servant manager 200. The arrows denote how a system component can move from one state to another, and the numbers after the arrow reflect what the next valid states are for the current state. For example, State 12. Destructed, can move to state 13. Unloading, where the system component is removed from memory.

The following rules govern how a system component may move from one state to another:

1. All of a system component's dependencies must be loaded before it may be loaded.

2. All of a system component's dependencies must be initialized before it may be initialized.

3. All of a system component's dependencies must be started before it may started.

4. All of a system component's dependants must be transient before it may be attenuated.

5. All of a system component's dependants must be stopped before it may be killed.

6. All of a system component's dependants must be destructed before it may destructed.

7. All of a system component's dependants must be unloaded before it may be unloaded.

8. If a system component that is being loaded will replace an pre-existing servant (e.g. upgrading a servant), the following actions must take place:

a. First, the servant manager 200 must confirm that if the system component is replaced, all existing functionality can also be replaced. For example, if servant SV1 is to be replaced, but servants SV2 and SV3 depend upon it. The servant manager 200 must make sure that servants SV2 and SV3 can also be replaced.

b. When a system component is reloaded, the new system component's state must match the state of the preexisting system component.

c. A replaced system component must be unloaded as quickly as possible. An end-user must make a confirm any action that will affect more than one system component.

Each system component has a servant agent 210 (e.g., object, data object, etc.) inside of (or accessible to) the servant manager 200. The role of servant agent 210 is to represent the system component in all servant manager 200's operations by fulfilling requests on the behalf of other agents or asking other agents to fulfill requests on its behalf. This leads to a distributed method of control where all servant agents 210 have the code for all of the rules of system component behavior. These agents cooperate together to fulfill user requests.

Since servant agents know mostly about themselves, their dependants, and their dependencies, a servant directory (not shown) is also available so that servant agent 210 may be able to lookup whether or not there are other agents which have the same component ID or version. Such a servant directory may be by objects in memory, in database objects in database facility 108, or in external files (not shown).

In a preferred embodiment of the present invention, servant manger 200 is a JAVA based program continuously running in memory on application server facility 104. As such, it will be appreciated by one having ordinary skill in the art that servant manager 200 utilizes system memory to maintain data in accordance with the rules described above, thereby facilitating delivery and execution of distributed applications across network 102 and the various facilities within system 100. Accordingly, it will be readily understood by one having ordinary skill in the art that servant manager 200 may coordinate the loading, unloading, executing, etc. of application components, such as a web server facility 106, a client 204, a cable service 206 and remote client service 208, database daemon 210, and several servants and daemons, SV1-SV3 and DM1-DM3, in accordance with rules defined above, in order to serve and facilitate a distributed application, such as an enhanced web application, to client 204 via network 102.

Additional system components may be necessary to facilitate applicant server functions, such as client management, database connections, server administration, messaging, etc. Accordingly, provided are such additional components.

Remote client service 202 functions as a communicator between network client 114 (i.e., components outside of the application server system 100) and the system components inside application server system 100. Remote client service 202 may be a computer module, JAVA program, applet, servlet, etc., configured to communicate to web server facility 106 (e.g., via JAVA RMI, HTTP, TCP/IP, etc.), to receive and process a request from network client 114, to register network client 114 (e.g., via a JAVA RMI registry), to locate a system component based on the request and reference network client 114 to the corresponding system component in order to initiate or facilitate an application, such as an enhanced web application. For example, remote client service 202 may initialize a JAVA RMI registry and register all system components with the registry to assign unique identifiers to each system component. Network client 114 is registered with remote client service 202 and obtains a lease (a lease is a way of keeping track of system processes; when a lease expires, the process is terminated). The remote client service 202 finds a system component or a particular revision of a system component, based upon the request and returns a remote reference to network client 114. Once the remote reference is given to network client 114, network client 114 removes itself from the registry and communicates directly with the referenced system component. An exemplary remote client service is illustrated and described in detail in co-owned, co-pending U.S. patent application Ser. No. ______ entitled “A REMOTE CLIENT MANAGER THAT FACILITATES AN EXTENDIBLE, MODULAR APPLICATION SERVER SYSTEM DISTRIBUTED VIA AN ELECTRONIC DATA NETWORK AND METHOD OF MAKING SAME,” filed on “______ #, 2000”, which is incorporated herein by reference.

Database daemon 210 is a special component that provides the necessary interface to connect to specific types of data sources, such as Informix, Oracle, or ODBC databases, and includes the proper drivers (e.g., Oracle JDBC, Informix JDBC, ODBC-JDBC Bridge, etc.) necessary to connect and access such databases. Database daemon 210 may be a stand alone program, JAVA servlet, applet, servant or other computer module configured to accept a data request (e.g., a string, etc.), establish a connection to a database, such as database facility 108, perform a database transaction (create, update, retrieve, delete, commit, rollback, etc.) based on said string, and return the data requested to the system component or module requesting the data. Accordingly, database daemon 210 may utilize a registry to keep track of clients and requests, may store data relating to each data source drive (i.e., database driver), and may utilize any other utility or program necessary to perform its functions. For example, the database daemon may utilize an object in memory that stores information about the database driver, such as ID, Name, Description, JDBC Class Name, etc.

Cable service 206 represents a specialized application service, such as a telecommunications service. Cable service 206 may be a program, JAVA servlet, applet, servant or other computer module configured to access and control other system components, such as database daemon 208, switch 116, central office 118, and validation facility 120, to provide a telecommunications service to client 114.

Additionally system components (represented by servants and daemons, SV1-SV3 and DM1-DM3) may added to the framework to assist with application services, to enhance or support existing system components, and to provide other necessary application functions. For example, a network daemon, a monitoring daemon, a time toolkit daemon, a remote administration daemon, and a data toolkit daemon.

A network daemon (not shown) may be added to open and manage TCP/ID sockets (open, lock, send and receive messages, unlock, close connections, etc.) in much the same way that the database daemon manages data sources and data source drivers. A network daemon can, for example, be a JAVA program, servlet, servant, etc. that tracks attributes that define a connection or socket. Such attributes may be the socket name, description, ID, host name (name of the host connected to the socket), IP address of the host, remote port of the connection, local port of the connection, lock object (the object locking the socket), and Listeners (a list of objects that notify when events occur). Accordingly, network daemon may be utilized to facilitate communication and messaging between system components.

A data toolkit daemon (not shown) works in conjunction with the database daemon and provides a set of commonly used data retrieval functions. These functions return preferably dynamic data objects, rather than Vectors that JCSOS used, but are not limited to dynamic data objects.

A monitor daemon (not shown) works through the aforementioned network daemon to provide some methods for digesting messages to and from remote hosts. It also keeps track of what monitors are alive. The monitor service supports multiple message formats, through the use of Monitor Message Digest Interfaces (MMDI). The MMDI provides a way to translate messages from their original form to their digested form. For example, the messages of some monitor may require packaging through the use of frame characters and escape codes. The MMDI is in charge of adding these extra codes when sending, and removing them upon retrieval.

A remote administration daemon (not shown) may be provide to allow remote server administration. Remote administration daemon may be a stand alone program, interface, console, etc. that is configured to access system 100 and the components therein to allow remote clients (e.g., a network client) to monitor and manage the entire server system 100, it's components and facilities. Accordingly, a server socket is provided and a command line interface to interact with various system components. The basic command line allows at least a user to manually load and unload modules, start and stop modules, and view any logs that have been created. Server administrators are well known, and a remote administration daemon will be readily understood by one having ordinary skill in the art.

A time toolkit daemon may be incorporated into system 100 in order to provide valuable time functions to the server system. A time toolkit daemon may simply be a JAVA program, servlet, servant, etc. that provides timer functions for keeping track of leases, connections, etc.

Accordingly, it will be readily appreciated by one having ordinary skill in the art, that system 100's modular, extendible design allows for the addition or modification of unlimited system components to enhance server capabilities, and that the powerful servant manager 200 allows additionally components to be distributed across network 102 to improve sharing and maintainability. It will be readily understood by one having ordinary skill in the art that servant manager 200 and remote client service 202 work together within the rules described above to serve modular, distributed applications, such as enhanced web applications, via network 102.

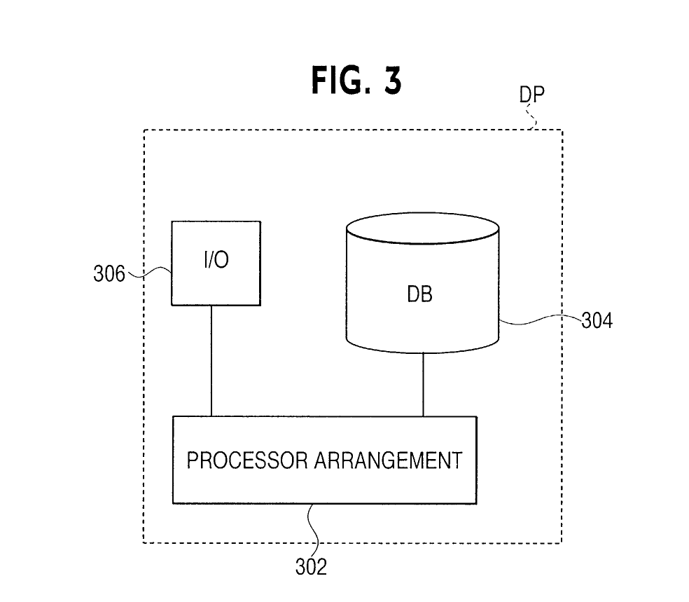

Referring now to FIG. 3, depicted therein is a block diagram of a computing system which may be used to implement server facilities, database facilities, and client facilities, to execute programs, API's, applets, utilities and other system components, etc. as described above with regard to FIGS. 1 and 2 in accordance with a preferred embodiment of the present invention. In particular, FIG. 3 depicts a data processing system DP which further includes a processor arrangement 302 including one or more processing elements, a data storage subsystem 304, an 10 facility 306. The arrangement of these structures shown with data processing system DP will be immediately understood by those skilled in the art.

Data processing system DP is configured to receive and transmit data to and from network facilities and devices, customer systems, vendor systems, etc. via protocols such as TCP/IP, HTTP, JAVA RMI, etc., execute compilers, runtime engines, API's, operating, design facilities, designers, editors, and web server systems necessary to facilitate the present invention.

Data storage subsystem 304 as shown within data processing system DP, will include database objects, tables, columns, extents, etc. necessary to facilitate the present invention. Accordingly, data storage subsystem 304 may be configured to store data in files, flash memory, etc.

### Operational Aspects of the Present Invention

Described next are methods for facilitating the delivery of distributed applications, such as enhanced web applications, across an electronic data network to a client.

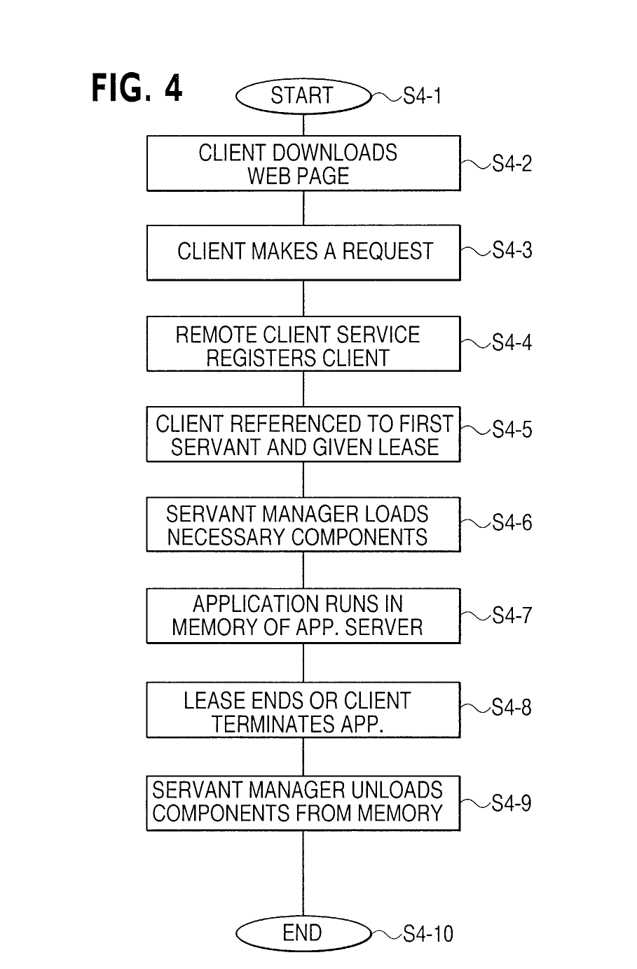

Referring now to FIG. 4, depicted therein is a flow chart of a method that facilitates designing and generating customized and localized web interface(s) via an electronic data network in accordance with a preferred embodiment of the present invention. In particular, processing begins at step S4-1 and immediately proceeds to step S4-2.

At step S4-2, a client web browser initiates an application by accessing a URL via the Internet and WWW (or other network) and downloads a web page. In a preferred embodiment of the present invention, the web page includes a JAVA applet which is executed within the web browser. The client web browser is configured as already described above with reference to network client 114. Processing proceeds next to step S4-3.

Next, at step S4-3, the applet makes a request for services to a remote client service via JAVA RMI. As already described above, a remote client facility, such as remote client service 202, configured to handle such requests, may reside on an application server coupled to the Internet and WWW, such as application server facility 104. Processing proceeds next to step S4-4.

Next, at step S4-4, the remote client service registers the client in a registry. This can be done as already described above with reference to remote client service 202. Processing proceeds next to step S4-5.

Next, at step S4-5, the first system component related to the request is located, and the client is referenced to the system component. For example, the JAVA applet of step 2 may initiate cable service 206. In this case, the remote client facility references the client to the cable service 210 (i.e., to the initiating module, JAVA program, sub-class, etc. for cable service 210) for execution. Processing proceeds next to step S4-6.

Next, at step S4-6, the system components necessary to execute the first system component are located and loaded. As already described above with reference to servant manager 200, the first component may be partially loaded to determine dependencies. Then, in accordance with the rules defined, the first system component and all dependencies are loaded. It will be appreciated that such system components and their dependencies may be distributed across many network facilities coupled to the Internet and WWW. Also, because of system 100's modular design, system components may be requested by multiple users, and accordingly, may already be loaded into memory when a particular client requests a service. Therefore, it may not be necessary to initiate the system component and its dependencies. Processing proceeds next to step S4-7.

Next, at step S4-7, the entire application is run in memory within the various network facilities. In a preferred embodiment of the present invention, the system components are JAVA servants which are loaded and run in the memory of application server facility 102. Via JAVA RMI and HTTP, the application is delivered to the client web browser via the Internet and WWW. It will also be appreciated that during the execution of the application, the JAVA applet may require additional services, and accordingly, may make additional requests to the application server system. Processing proceeds next to step S4-8.

Next, at step S4-8, either the lease terminates or the client manually terminates the application. At the termination of the lease, all processes are terminated, such as by servant manager 200. Processing proceeds next to step S4-9.

Next, at step S4-9, all system components no longer in use are unloaded from memory. This can be accomplished as already described with reference to servant manager 200 and the associated rules.

Processing terminates at step S4-10.

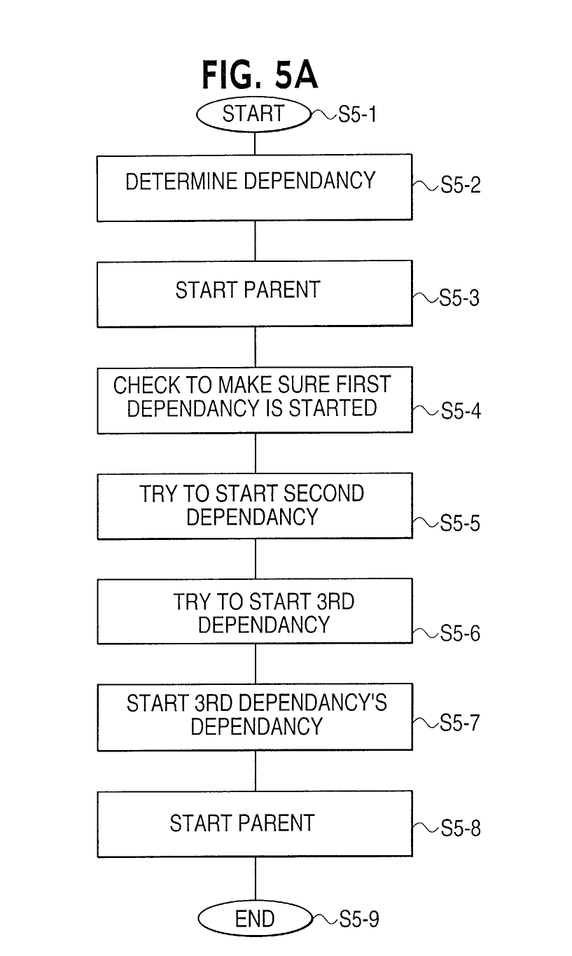

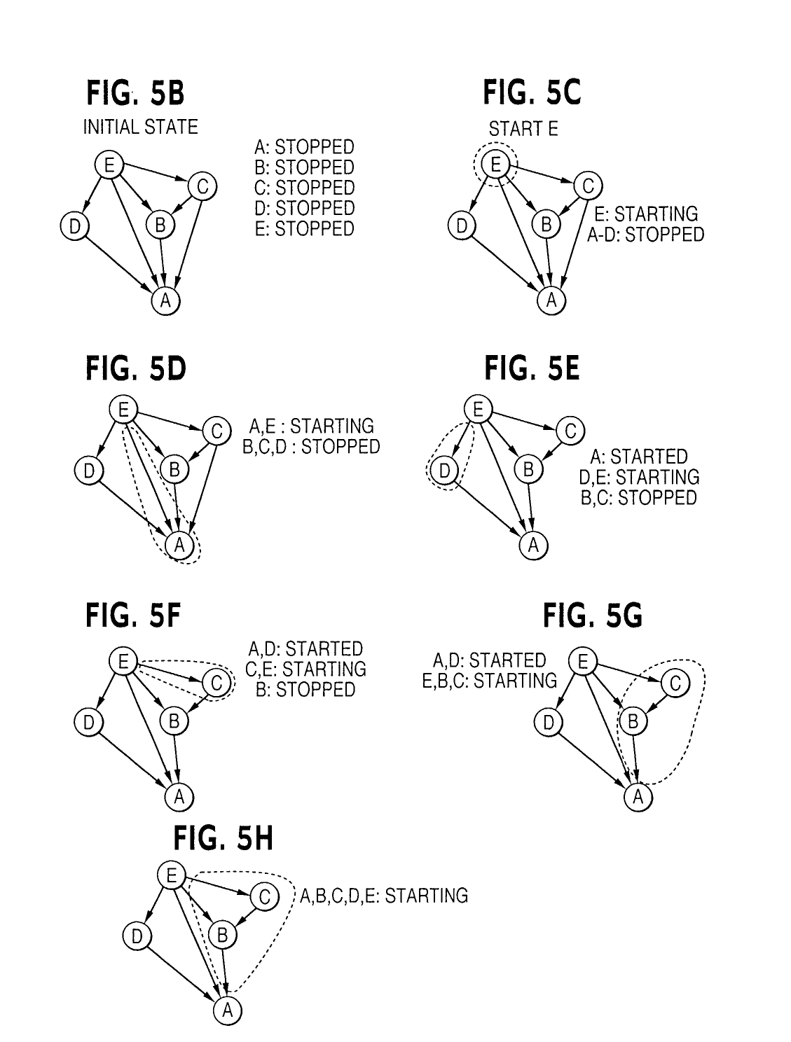

Referring now to FIGS. 5A-5H, depicted therein is a flow chart of a method for dynamically loading JAVA servants and supporting figures for each step in accordance with a preferred embodiment of the present invention. In particular, processing begins at step S5-1 and immediately proceeds to step S5-2.

At step S5-2, a JAVA servant is initiated in accordance with the rules described already above with reference to servant manager 200. Referring to FIG. 5B, shown are 5 JAVA servants, A-E. The arrows denote dependencies. Therefore, servant E is dependent on servants A, B, C and D; servant B is dependent on servant A; servant C is dependent on servants A and B; servant D is dependent on servant A; and servant A has no dependencies. The dependencies are determined, such as by scanning servant E to find servants A-D, then by scanning JAVA servants A-D. Or, alternatively, servant E could be partially loaded to determine dependencies, then each dependent could be partially loaded as they are started. A servant manager, such as servant manager 200 already described above with reference to FIG. 2 may be used to perform these task. As shown if FIG. 5B, all servants are currently in a state of “stopped.” Processing proceeds next to step S5-3.

At step S5-3, the parent servant is started. In this particular example, servant E is the parent. Servant E is moved into the “starting” state by a servant manager, such as servant manager 200 already described above. Referring to FIG. 5C, it is shown that servant E is in the “starting” state and servants A-D are still in the “stopped” state. Processing proceeds next to step S5-4.

At step S5-4, servant E's dependencies must all be “started” before E can be “started.” Therefore, the first dependency, servant A, is moved into the “starting” state by a servant manager, such as servant manager 200 already described above. As shown in FIG. 5D, servants A and E are now in the “starting” state, and servants B-D are still in the “stopped” state. Processing proceeds next to step S5-5.

At step S5-5, the next dependency, servant D is moved into the “starting” state by a servant manager, such as servant manager 200 already described above. Also, since servant A has no dependencies, servant A moves from the “starting” state to the “started” state. Referring to FIG. 5E, it is shown that servant A is in the “started” state, servants D and E are in the “starting” state, and servants B and C are still in the “stopped” state. Processing proceeds next to step S5-6.

At step S5-6, the next dependency, servant C is moved into the “starting” by a servant manager, such as servant manager 200 already described above. Also, since servant D has no dependencies, servant D moves from the “starting” state to the “started” state. Referring to FIG. 5F, it is shown that servants A and D are in the “started” state, servants C and E are in the “starting” state, and servant B remains in the “stopped” state. Processing proceeds next to step S5-7.

At step S5-7, the final dependency, servant B is moved into the “starting” by a servant manager, such as servant manager 200 already described above. Also, since servant C is dependent on servant B and servant B is not “started”, servant C remains in the “starting” state. Referring to FIG. 5G, it is shown that servants A and D are in the “started” state, servants B, C and E are in the “starting” state, and no servants remain in the “stopped” state. Processing proceeds next to step S5-8.

At step S5-8, since servant B is only dependent on servant A, and servant A is “started,” servant B now moves to the “started” state. Similarly, once servant B is “started”, servant C may move into the “started” state. Similarly, once servant C is “started”, servant E may move into the “started” state. Referring to FIG. 5H, it is shown that servants A-E, all are in the “started” state, and no servants remain in the “stopped” state. Processing proceeds next to step S5-9.

Processing is terminated at step S5-9.

The method described above is merely exemplary and is based on a particular set of dependencies. However, it will be readily understood by one having ordinary skill in the art, that by following the rules described above with reference to FIG. 2 and servant manager 200, unlimited sets of dependencies may be handled in order to load and delivery modular applications.

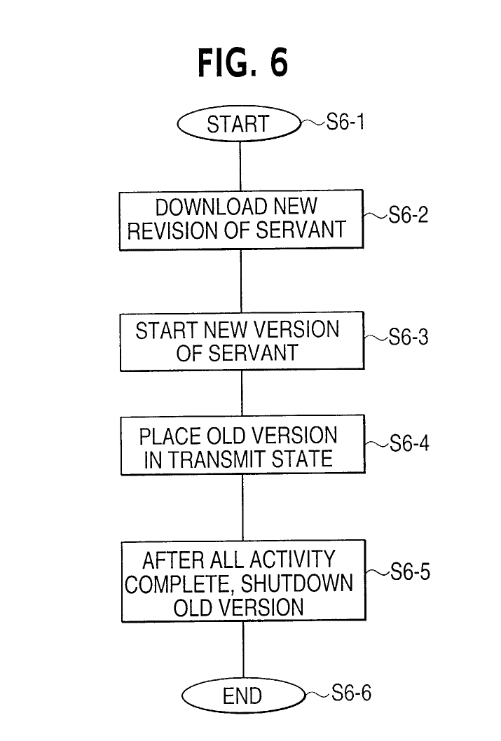

Reference now is made to FIG. 6, depicted therein is a flow chart of a method for upgrading a system component without making the system component unavailable in accordance with a preferred embodiment of the present invention. In particular, processing begins at step S6-1 and immediately proceeds to step S6-2.

At step S6-2, a new revision of a system component is downloaded to the server facility on which it resides. As described above with reference to servant manager 200, the new revision will be uniquely identified. The downloading of the system component may be performed manually or through a system administrator, such as the remote administration daemon described above with reference to FIG. 2. Processing proceeds next to step S6-3.

At step S6-3, the new version of the system component is loaded into memory. This is done by a servant manager, such as servant manager 200 or by a system administrator, such as the remote administration daemon described above with reference to FIG. 2, and in accordance with the rules described above with reference to FIG. 2 Processing proceeds next to step S6-4.

At step S6-4, the old revision of the system component (i.e., the system component being upgraded) is placed into a transient state. As already described above with reference to FIG. 2, the system component will not accept any new activity, and therefore, all new activity for that system component is shifted to the already loaded new revision based on the rules already described above with reference to FIG. 2. Processing proceeds next to step S6-5.

At step S6-5, after all activity related to the old revision of the system component is completed (i.e., its queue is empty), the old revision is shut down and removed from memory consistent with the rules already described above with reference to FIG. 2. Processing proceeds next to step S6-6.

At step S6-6, processing is terminated.

Thus, having fully described the present invention by way of example with reference to the attached drawing figures, it will be readily appreciated that described above are methods for managing individual components of an application server system and the applications that are served thereby. It will be appreciated that the methods described above are merely exemplary and that the present invention is not limited thereto; and, that the modular framework described above with reference to FIGS. 1 and 2 is extremely powerful and allows for many modifications and enhancements.

Additionally, user session data may be maintained through standard programming practices, such as creating an object that contains all user session data, and updating the object during the various stages of processing (e.g., passing the object, etc.).

Additionally, group permission and security may be similarly handled with standard security methods. Permissions may be stored in an object, DBA tables, customized database objects, etc., and maintained during the various stages of processing.

Accordingly, it will be understood by one having ordinary skill in the art that multiple, customized and localized web interfaces may be dynamically generated in response to a request, and in real-time, while standardizing the underlying data and content to be delivered.

What is claimed is:

1. An extendible, modular application server distributed via an electronic data network, comprising:
a remote client facility configured to receive a request via said electronic data network from a network client, to register said network client, to locate a first network facility residing on said electronic data network based on said request and reference said client to said first network facility in order to initiate a distributed application;
at least one business function facility residing on said electronic data network and configured to access and control a second network facility in order to perform a business function, said at least one business function facility including said first network facility and said second network facility corresponding to said first network facility;
at least one remote network facility residing on said electronic data network and configured to be accessed and controlled by said at least one business function facility in order to facilitate said business function, said at least one remote network facility including said second network facility corresponding to said first network facility; and
a facility manager configured to track, manage and maintain said remote client facility, said at least one business function facility and at least one remote network facility, to locate, load and execute in memory said first network facility and said second network facility to complete delivery of said application to said network client via said electronic data network.

2. The system according to claim 1, wherein said remote client facility is further configured to select a specific revision of said first network facility based on said request.

3. The system according to claim 1 wherein said at least one remote network facility includes a data source driver configured to provide a database connection to said at least one data source.

4. The system according to claim 1, wherein said at least one business function facility and said at least one remote network facility are a JAVA servants, said network client registers with said remote client facility via said electronic data network via JAVA RMI, and said remote client facility provides said network client a reference to said first network facility via JAVA RMI.

5. The system according to claim 1, wherein said network client is a JAVA applet running within a web browser.

6. The system according to claim 1, wherein said at least one business function facility includes a system for generating dynamic web interfaces that are customized and localized.

7. The system according to claim 1, wherein said at least one remote network facility includes JAVA servlets, JAVA servants, JAVA programs, JAVA applets, graphics objects and data objects.

8. The system according to claim 1, wherein said network client is a web browser.

9. The system according to claim 1, wherein said electronic data network is the Internet and World Wide Web.

10. The system according to claim 1, wherein said facility manager is a JAVA program residing on a server facility and said at least one business function facility and said at least one remote network facility are JAVA servants that run in the memory of said server facility.

11. An extendible, modular application server system distributed via an electronic data network, comprising:
a network client configured to access a web server facility via said electronic data network to receive and execute at least one web interface;
a web server facility coupled to said electronic data network and configured to store and to serve said at least one web interface, said at lest one web interface configured to initiate an application by making a request via said electronic data network;
a remote client facility configured to receive a request via said electronic data network from said at least one web interface executing on said network client, to register said network client, to locate a first network facility residing on said electronic data network based on said request and reference said network client to said first network facility in order to initiate a distributed application;
at least one business function facility residing on said electronic data network and configured to access and control a second network facility in order to perform a business function, said at least one business function facility including said first network facility;
at least one remote network facility residing on said electronic data network and configured to be accessed and controlled by said at least one business function facility in order to facilitate said business function, said at least one remote network facility including said second network facility which corresponds to said first network facility; and
a facility manager configured to track, manage and maintain said remote client facility, said at least one business function facility and at least one remote network facility, to locate, load and execute in memory network facilities residing on said electronic data network, to partially load said first network facility into memory to locate and load said second network facility which corresponds to said first network facility and to complete loading said first network facility to complete delivery of said application to said network client via said electronic data network.

12. The application server in claim 11, wherein said at least one remote network facility includes a network daemon configured to access and control network facilities, to open and manage TCP/IP sockets relating to said server facility and said electronic data network residing on said electronic data network, and to send and receive messages via said TCP/IP sockets.

13. The application server in claim 11, wherein said at least one remote network facility includes a database daemon configured to access and control network facilities, to open and manage connections to at least one data source residing on said electronic data network, and to query and maintain data in said at least one data source;

14. The application server in claim 11, wherein said at least one remote network facility includes a time toolkit daemon configured to access and control network facilities residing on said electronic data network, and to provide scheduling, stopwatch, and timer functions;

15. The application server in claim 11, wherein said at least one remote network facility includes a content server daemon configured to access and control network facilities residing on said electronic data network, to provide an interface to an email server system, and to provide an interface to a web server system.

16. The application server in claim 11, wherein said at least one remote network facility includes a remote administration service residing on a server facility and configured to access and control network facilities residing on said electronic data network, and to monitor and manage said server facility.

17. A method for serving modular, distributed applications comprising the steps of:
at a network client, accessing a remote client service via an electronic data network and passing a facility request to said remote client service;
at said remote client service, locating a first network facility based on said facility request, registering said network client, and referring said first network facility to said network client;
at a servant managing facility, partially loading said first network facility;
at said servant managing facility, determining at least one second network facility necessary to execute said first network facility;
at said servant managing facility, locating and loading said second network facility; and
at said servant managing facility, completing loading said first network facility to fulfill said facility request to said network client.

18. The method according to claim 17, wherein said remote client service is further configured to select a specific revision of said first network facility based on said facility request.

19. The method according to claim 17, wherein said first and second network facilities are a JAVA servants, said network client registers with said remote client service via said electronic data network via JAVA RMI, and said remote client facility provides said network client a reference to said first network facility via JAVA RMI.

20. The method according to claim 17, wherein said network client is a JAVA applet running within a web browser.

21. The method according to claim 17, wherein said network client is a web browser.

22. The method according to claim 17, wherein said electronic data network is the Internet and World Wide Web.

23. The method according to claim 17, wherein said servant managing facility is a JAVA program residing on a server facility and said first and second network facilities are JAVA servants that run in the memory of said server facility.
